(19) United States
(12) Patent Application Publication
(10) Pub. No.: US 2014/0265261 A1
(43) Pub. Date: Sep. 18, 2014

(54) STEEL REINFORCED PERSONAL AIRBAG SYSTEM

(71) Applicant: FORD GLOBAL TECHNOLOGIES, LLC, Dearborn, MI (US)

(72) Inventors: Dennis Michael Surdu, Canton, MI (US); Brian C. Slane, Flat Rock, MI (US); Nicholas Mazzocchi, Ann Arbor, MI (US)

(73) Assignee: Ford Global Technologies, LLC, Dearborn, MI (US)

(21) Appl. No.: 13/830,707

(22) Filed: Mar. 14, 2013

(51) Int. Cl. B60R 21/20

(52) U.S. Cl. CPC B60R 21/20
USPC 280/728.2; 29/428

(57) ABSTRACT

An airbag assembly having a canister portion and a chute portion. The chute portion has a plurality of windows in order to engage hooks of the canister portion. In order to reinforce the hook and window engagements, an insert molded reinforcing strip is molded into the chute. The reinforcing strip may be more than one reinforcing strip or a single continuous strap molded around the entire perimeter of the chute. Another embodiment also includes a hinged steel door insert molded into the bottom surface of the chute providing additional reinforcement to the body of the chute.

### FIELD OF THE INVENTION

The present invention generally relates to a vehicle airbag system and the method for constructing therefore.

### BACKGROUND OF THE INVENTION

Known approaches of airbag assemblies often fail during deployment causing potentially dangerous pieces of the assembly to enter into the vehicle body or causing total replacement of the airbag assembly after deployment.

### SUMMARY OF THE INVENTION

One aspect of the present invention includes an airbag assembly having an airbag canister which includes at least one hook disposed about a perimeter of the airbag canister. The assembly further includes a chute which has a body and at least one window extending through the body, wherein the hooks and the windows are operably engaged. A reinforcing strip is disposed on the chute and has at least one aperture which is aligned with the at least one hook and the at least one window in order to reinforce the connection between the airbag canister and the chute resulting in an robust system configured to controllably deploy during a vehicle collision event.

Another aspect of the present invention includes an airbag assembly which has an airbag canister and includes a hook disposed about a perimeter of the airbag canister. The assembly also includes a chute which has a plurality of windows. At least one reinforcing strip is insert molded into the chute and the reinforcing strip includes a plurality of apertures which are aligned with the hooks and the windows. The hooks engage the windows and the apertures.

Yet another aspect of the present invention includes a method for producing an airbag. The method includes providing an airbag canister which includes at least one hook disposed about the perimeter of the canister and the chute including a body having at least one window extending through the body. The at least one hook is operably engaged with the at least one window. Finally, the at least one reinforcing strip is insert molded into the chute. The reinforcing strip has at least one aperture which is aligned with the at least one hook and the at least one window. The at least one hook operably engages the at least one window in the at least one aperture.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is an exploded side perspective view of one embodiment of the present invention prior to the insertion of the reinforcing strip;

FIG. 2 is a side elevational view of the reinforcing strip of the present invention;

FIG. 3 is a bottom perspective view of one embodiment of a chute of the present invention;

FIG. 4 is a bottom perspective view of another embodiment of the chute of the present invention;

FIG. 5 is a top perspective view of yet another embodiment of the chute of the present invention;

FIG. 6 is a bottom perspective view of one embodiment of the airbag assembly of the present invention;

FIG. 7 is a top exploded perspective view of one embodiment of the airbag assembly of the present invention;

FIG. 8 is a top exploded perspective view of one embodiment of the airbag assembly of the present invention having a bottom surface of an airbag canister removed; and

FIG. 9 is a top perspective view of yet another embodiment of the chute of the present invention.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As shown in FIG. 1, reference number 10 generally designates an airbag assembly. The airbag assembly 10 generally includes of an airbag canister 20 and an airbag chute 40. The airbag canister 20 has a top surface 24 and a bottom surface 22 and is generally made of a plastic polymer material. The canister 20 further includes a plurality of sidewalls 26 which connect the top surface 24 and the bottom surface 22. The top surface 24, the bottom surface 22, and the perimeter sidewalls 26 create a compartment 27, which houses an airbag 29 when the airbag 29 is not deployed. The bottom surface 22 of the airbag canister 20 includes an inflator 30, a mounting bracket 28, and a plurality of mounting screws 32 mounted to the bottom surface 22 of the airbag canister 20. The bottom surface 22 of the airbag canister 20 further includes a plurality of apertures 23 configured to receive the inflator 30, the mounting screws 32, and the mounting bracket 28. The bottom surface 22 of the airbag canister 20 further includes a tether cutter 34. The tether cutter 34 is configured to deploy the airbag 29 to a desired length based on individual passengers. Attachment brackets 36 are attached to opposite sidewalls 26 of the airbag canister 20 and provide an attachment mechanism for the airbag canister 20 to engage the airbag chute 40. Additionally, the airbag canister 20 includes a plurality of hooks which are disposed around the perimeter sidewalls 26 and are configured to provide engagement with the airbag chute 40.

Further, FIG. 1 shows that the airbag chute 40 has a top surface 42, has at least one perimeter sidewall 44 extending upwardly from the top surface 42, and is generally made of a plastic polymer material. Preferably, the plastic polymer is TEO Mitsubishi Chemical (TT850N). The perimeter sidewall 44 and the top surface 42 create a lip portion 46 on the top surface 42. The top surface 42 and the perimeter sidewalls 44 form an aperture configured to receive the airbag canister 20. The perimeter sidewalls 44 of the airbag chute 40 also include a plurality of windows 50 extending therethrough. The top surface 42 of the airbag chute 40 is generally rounded and includes a plurality of apertures 43. The plurality of windows 50 are generally configured to receive hooks 38 of the airbag canister 20. An outside surface of the perimeter sidewall 44 also includes wedge-shaped support protrusions 52 which provide further support to the lip portion 46 of the top surface 42 and the sidewall 44. Side apertures 54 are also included in the perimeter sidewall 44 and are configured to receive the attachment brackets 36 of the airbag canister 20.

FIG. 2 shows a reinforcing strip 60 including a plurality of reinforcing apertures 62 and mounting apertures 63. The mounting apertures 63 may or may not be present. As shown in FIG. 3, the reinforcing strip 60 is insert molded into or otherwise securely fastened to the perimeter sidewall 44 of the airbag chute 40. The reinforcing strip 60 and its reinforcing apertures 62 are in alignment and configured to reinforce the plurality of windows 50 of the airbag chute 40. The reinforcing strip 60 is generally rectangular in shape and the apertures 62 and 63 are arranged in a generally alternating pattern in order to more securely fasten the strip 60 to the airbag chute 40. The strip 60 may be mounted to the airbag chute 40 through mounting apertures 63 by any suitable mechanical means. The apertures 62 and 63 of the reinforcing strip 60 may be of any shape including square, rectangular, circular, triangular, etc, in order to more securely fasten the strip 60 to the airbag chute 40, and thus reducing the tendency for the airbag chute 40 to rip out during deployment. The reinforcing strip 60 is generally made of stamped steel or any other reinforcing material. The steel of the reinforcing strip 60 may be hard or cold rolled, stamped, forged, or cast. Additionally, the reinforcing strip 60 has a thickness of at least 1 mm. The strip 60 can be also adapted to a variety of different airbag chute 40 dimensions based on specific instrument panel designs.

As shown in FIG. 3, one embodiment of the reinforcing strip 60 can be multiple reinforcing bands insert molded into or otherwise attached to the airbag chute 40. In another embodiment, shown in FIG. 4, the reinforcing strip 60 is a single continuous strap molded into or otherwise attached to the entire perimeter sidewall 44 of the airbag chute 40. The reinforcing strip 60 provides extra support to the airbag chute 40 and reduces the tendency for the plurality of windows 50 or the airbag chute 40 to rip during deployment of the airbag 29.

As shown in FIG. 5, a steel or steel insert molded door 70 covering the top surface 42 of the airbag chute 40 is illustrated. The door 70 has a hinge 72 which is continuous with the reinforcing strip 60. The hinge 72 is integrally formed with the steel door 70. In operation, the airbag 29 is deployed, in the direction of Arrow A, through the airbag chute 40, causing the door 70 to swing open on its hinge 72. The steel hinge 72 and steel door 70 provide additional reinforcement to the airbag chute 40, reducing the tendency to rip the airbag chute 40 during airbag 29 deployment.

In operation, and as shown in FIG. 6, the airbag canister 20 is engaged with the airbag chute 40 such that the hooks 38 and the attachment brackets 36 of the airbag canister 20 are engaged with the plurality of windows 50 and the side apertures 54 of the airbag chute 40, respectively. During a collision event, the inflator 30 is actuated to inflate the airbag 29 such that the airbag 29 extends out of the compartment 27 and through the top surface 24 of the airbag canister 20. The airbag 29 is then deployed, in the direction of Arrow A, through the top surface 24 of the airbag chute 40 and out into a body of a vehicle to provide protection to a vehicle passenger. In prior art configurations, during deployment, the pressure from the deploying airbag 29 could possibly cause the airbag 29 to completely destroy the airbag chute 40, resulting in replacement of the entire airbag assembly 10. However, the reinforcing strip 60 provides added reinforcement to the plurality of windows 50 and the sidewalls 44 of the airbag chute 40, reducing the tendency to rip the airbag chute 40 during deployment of the airbag 29. The reinforcing strips 60 are especially important for leather applications where the airbag chute 40 needs to be more robust and the airbag 29 must deploy at a faster rate in order to enter into the body of the vehicle.

In the alternate embodiment, shown in FIG. 5, which includes the steel or steel insert molded door 70 and the hinge 72, once the airbag 29 is deployed, the airbag 29 bursts through the top surface 42 of the airbag chute 40 and causes the door 70 to rotate on its hinge 72, thereby allowing the airbag 29 to deploy into the body of the vehicle in front of a passenger. This provides added structure and support to the airbag chute 40 to effectively reinforce the airbag assembly 10 and to prevent the failure of the airbag chute 40.

In another embodiment shown in FIG. 7, the airbag chute 40 has a top surface 42 including a door 74 generally made of the same plastic polymer material as the airbag chute 40 to allow the airbag 29 to deploy through the airbag chute 40 and into the vehicle body.

FIG. 8 again shows the top surface 42 of the airbag chute 40. However, in this embodiment, the top surface 24 of the airbag canister 20 has been removed to more clearly show the compartment 27, which houses the airbag 29 prior to deployment.

In yet another embodiment shown in FIG. 9, the top surface 42 of the airbag chute 40 includes a plurality of steel filets 80 in order to strengthen the door 74 in the deployment direction. The door 74 further includes at least one steel hinge reinforcement 82. The steel hinge reinforcement 82 and the door 74 include apertures 84 strategically placed to allow the plastic polymer to flow through during the molding process. Proper placement of the apertures 84 ensures that maximum strength of the airbag assembly 10 is maintained.

Leather wrapped applications often require higher burst pressure for successful airbag deployment requiring more robust airbag systems. This reinforced airbag assembly 10 provides the necessary strength to reduce chute failures during deployment.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is to be understood that variations and modifications can be made on the aforementioned structure and methods without departing from the concepts of the present invention, and further it is to be understood that such concepts are intended to be covered by the following claims unless these claims by their language expressly state otherwise.

What is claimed is:

1. An airbag assembly comprising:
an airbag canister including at least one hook disposed about a perimeter of the airbag canister;
a chute including a body having at least one window extending therethrough, wherein the at least one hook is operably engaged with the at least one window; and
a reinforcing strip disposed on the chute and including at least one aperture aligned with the at least one hook and the at least one window to thereby reinforce the connection between the airbag canister and the chute, resulting in a robust system configured to controllably deploy during a vehicle collision event.

2. The airbag assembly of claim 1, wherein the reinforcing strip is a single, contiguous strap molded into an entire perimeter of the body of the chute.

3. The airbag assembly of claim 1, wherein the reinforcing strip comprises a plurality of reinforcement bands.

4. The airbag assembly of claim 1, wherein the reinforcing strip is comprised of stamped steel.

5. The airbag assembly of claim 1, wherein the at least one aperture is substantially square in shape.

6. The airbag assembly of claim 1, wherein the chute further comprises a steel door contiguous with the reinforcing strip.

7. The airbag assembly of claim 6, wherein the steel door is insert molded into the chute.

8. The airbag assembly of claim 6, wherein the steel door further comprises a hinge contiguous with the reinforcing strip.

9. An airbag assembly comprising:
an airbag canister including a plurality of hooks disposed about a perimeter of the airbag canister;
a chute having a plurality of windows;
at least one reinforcing strip insert molded into the chute and including a plurality of apertures aligned with the plurality of hooks and the plurality of windows, wherein the plurality of hooks operably engage the plurality of windows and the plurality of apertures.

10. The airbag assembly of claim 9, wherein the at least one reinforcing strip is a single, contiguous strap molded into an entire perimeter of a body of the chute.

11. The airbag assembly of claim 9, wherein the at least one reinforcing strip is comprised of stamped steel.

12. The airbag assembly of claim 9, wherein the plurality of apertures are substantially square in shape.

13. The airbag assembly of claim 9, wherein the chute further comprises a steel door contiguous with the reinforcing strip.

14. The airbag assembly of claim 13, wherein the steel door is insert molded into the chute.

15. The airbag assembly of claim 13, wherein the steel door further comprises a hinge contiguous with the reinforcing strip.

16. A method of producing an airbag, comprising:
providing an airbag canister including at least one hook disposed about a perimeter of the airbag canister and a chute including a body having at least one window extending therethrough;
engaging the at least one hook with the at least one window; and
insert molding a reinforcing strip into the chute that includes an aperture aligned with the at least one hook and the at least one window, wherein the at least one hook operably engages the at least one window and the aperture.

17. The method of claim 16, wherein the at least one reinforcing strip is a single, contiguous strap molded into an entire perimeter of the body of the chute.

18. The method of claim 16, wherein the at least one reinforcing strip is comprised of stamped steel.

19. The method of claim 16, wherein the at least one aperture is substantially square in shape.

20. The method of claim 16, wherein the chute further comprises a steel door insert molded into the chute and contiguous with the reinforcing strip and a hinge.
